(19) United States
(12) Patent Application Publication
(10) Pub. No.: US 2016/0187368 A1
(43) Pub. Date: Jun. 30, 2016

(54) SYSTEMS AND METHODS OF DETECTING FAILURE OF AN OPENING SENSOR

(71) Applicant: Google Inc., Mountain View, CA (US)

(72) Inventors: Yash Modi, San Mateo, CA (US); Shao-Po Ma, Mountain View, CA (US)

(21) Appl. No.: 14/585,257

(22) Filed: Dec. 30, 2014

(51) Int. Cl. G01P 15/00; G08B 29/04; G01P 21/00

(52) U.S. Cl. CPC G01P 15/00; G01P 21/00; G08B 29/04

(57) ABSTRACT

Systems and methods of security are provided, including a sensor having an accelerometer and an electronic compass to generate motion data and position data, respectively, in response to movement of the sensor by a force, a processor communicatively coupled to the sensor, where processor identifies a displacement of the sensor from a mounting position according to the generated motion data and position data that is transmitted to the processor.

### BACKGROUND

In typical security systems, detecting faults with sensors is done with traditional fault checking or in real-time. The traditional fault checking relies upon non-real time checking, such as periodic checks, or “heartbeat” pulses that are sent from the sensor of the security system to a controller to inform the controller that the sensor is still functioning. As such, the traditional fault checking does not provide the controller of the security system with real-time feedback. Real-time checking in present security systems is typically done with switches, where a loss of contact with a backplate will open the switch, therefore informing a controller of the security system that the sensor is not functioning normally. The present real-time systems typically require additional hardware from traditional fault checking systems. However, present real-time systems do not provide information to the controller as to the cause of the fault.

### BRIEF SUMMARY

According to an embodiment of the disclosed subject matter, a security system having sensors provides real-time feedback to a controller regarding an operating condition of a sensor. The sensors of the security system disclosed herein provide information to a controller to identify and classify any faults of a sensor in real-time. Sensors as disclosed herein may include an accelerometer and/or an electronic compass, and may determine if there is a falling off event of the sensor, where the sensor is dislodged and/or displaced by an event.

According to an embodiment of the disclosed subject matter, a system is provided that includes a sensor having an accelerometer and an electronic compass to generate motion data and position data, respectively, in response to movement of the sensor by a force, a processor communicatively coupled to the sensor, where processor identifies a displacement of the sensor from a mounting position according to the generated motion data and position data that is transmitted to the processor.

According to an embodiment of the disclosed subject matter, a method is provided that includes generating, by an accelerometer and an electronic compass of a sensor, motion data and position data, respectively, in response to movement of the sensor by a force, and identifying, based upon the generated motion data and the position data, a displacement of the sensor from a mounting position.

According to an embodiment of the disclosed subject matter, means for determining a falling off event of a sensor are provided including generating, by an accelerometer and an electronic compass of a sensor, motion data and position data, respectively, in response to movement of the sensor by a force, and identifying, based upon the generated motion data and the position data, a displacement of the sensor from a mounting position.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIGS. 1A-1B shows an example sensor according to an embodiment of the disclosed subject matter.

FIGS. 2A-2B show an example sensor according to an embodiment of the disclosed subject matter.

FIGS. 3-4 show example operations of methods of detecting a falling off event for a sensor according to embodiments of the disclosed subject matter.

FIG. 5 show a security system having a sensor network according embodiments of the disclosed subject matter.

FIG. 6 shows a remote system to aggregate data from multiple locations having security systems according to an embodiment of the disclosed subject matter.

FIG. 7 shows a computing device according to an embodiment of the disclosed subject matter.

### DETAILED DESCRIPTION

According to embodiments of the disclosed subject matter, a security system of a smart-home environment having sensors may provide real-time feedback to a controller of the system regarding whether a sensor is operating normally. The sensors of the security system disclosed herein provide information to a controller to identify and classify any faults of a sensor in real-time. Sensors as disclosed herein may include an accelerometer and/or an electronic compass, and may determine if there is a falling off event of the sensor, during which the sensor is dislodged and/or displaced by an event.

The sensors may be disposed, for example, on a door and or window of a home or building. When mounted and/or installed, the sensors may be calibrated and/or configured so as to set a range of motion, displacement, force, acceleration, and the like for the sensor. When the sensor outputs data that is outside the range of motion, displacement, force, acceleration, or the like when compared to the calibrated range of values for the sensor, the system may determine that the sensor has been dislodged partially or completely from its mounted position (e.g., position has been moved as a result of an intruder or other motion event, and/or the sensor has fallen off). In some embodiments, the sensor may transmit its new location if it has been displaced and/or the amount of displacement (e.g., the amount from the original mounted position from which the sensor was calibrated and/or configured). The sensor may determine the amount of its displacement by itself (e.g., using data detected by the sensor, and comparing it to calibrated values), and/or from one or more other sensors of the security system (e.g., that may be within predetermined distance from the sensor). That is, the system may determine whether the sensor needs to be remounted and/or needs to be recalibrated and/or reconfigured.

In embodiments of the disclosed subject matter, the security system and/or the smart-home environment may determine whether one or more sensors has failed, malfunctioned, lost a portion of a sensing range and/or capability, has been dislodged from its mounted position, or the like. For example, the sensor may transmit a notification (e.g., to a controller of the security system) when the sensor has been at least partially displaced, and/or is unable to detect motion, acceleration, displacement, location, force, or the like in a set configuration range. The notification may include an operating condition of the sensor (e.g., displaced from the mounted location, partial and/or full loss of sensing capability range, or the like). In some embodiments, when the sensor has failed, been at least partially displaced, experienced a loss of at least a portion of sensing functionality, or the like, one or more other sensors proximately located to the sensor may be used to compensate for the loss of detection, functionality, or the like.

The sensor system of the disclosed subject matter makes it easy to determine when a sensor has been dislodged and/or encountered a fault condition, and determine the reason for the dislodgement and/or fault condition.

Embodiments disclosed herein may use one or more sensors. In general, a “sensor” may refer to any device that can obtain information about its environment. Sensors may be described by the type of information they collect. For example, sensor types as disclosed herein may include motion, smoke, carbon monoxide, proximity, temperature, time, physical orientation, acceleration, location, entry, presence, pressure, light, sound, and the like. In particular, the sensors disclosed herein may include an accelerometer and an electronic compass. A sensor also may be described in terms of the particular physical device that obtains the environmental information. For example, an accelerometer may obtain acceleration information, and thus may be used as a general motion sensor and/or an acceleration sensor. A sensor also may be described in terms of the specific hardware components used to implement the sensor. For example, a temperature sensor may include a thermistor, thermocouple, resistance temperature detector, integrated circuit temperature detector, or combinations thereof. A sensor also may be described in terms of a function or functions the sensor performs within an integrated sensor network, such as a smart home environment as disclosed herein. For example, a sensor may operate as a security sensor when it is used to determine security events such as unauthorized entry. A sensor may operate with different functions at different times, such as where a motion sensor is used to control lighting in a smart home environment when an authorized user is present, and is used to alert to unauthorized or unexpected movement when no authorized user is present, or when the security system is in a particular operation mode, or the like (e.g., a “home” mode, a “stay” mode, an “away” mode, a “vacation” mode, a “transition” mode, etc. according to the amount of activity in the home by an occupant, whether the occupant is away from the home, whether the occupant is leaving the home, or the like). In some cases, a sensor may operate as multiple sensor types sequentially or concurrently, such as where a temperature sensor is used to detect a change in temperature, as well as the presence of a person or animal. A sensor also may operate in different modes at the same or different times. For example, a sensor may be configured to operate in one mode during the day (e.g., when the security system is in a home mode, an away mode, or the like) and another mode at night (e.g., a stay mode, an away mode, or the like). As another example, a sensor may operate in different modes based upon a state of a home security system or a smart home environment, or as otherwise directed by such a system.

Data generated by one or more sensors may indicate patterns in the behavior of one or more users and/or an environment state over time, and thus may be used to “learn” such characteristics. In particular, in the embodiments of the disclosed subject matter, sensors may provide real-time information regarding their operational status, and, when a sensor is determined to not be operating normally, provides information to the controller as to the cause of the fault. The source of faults of a sensor may be identified, for example, according to a comparison of data gathered by the sensor (e.g., accelerometer and/or electronic compass data) with pre-stored data that characterizes a particular event (e.g., sensor has fallen off and/or been dislodged, a break-in attempt to a home and/or building in an area being monitored by the sensor, and the like).

In general, a “sensor” as disclosed herein may include multiple sensors or sub-sensors, such as where a position sensor includes both a global positioning sensor (GPS) as well as a wireless network sensor, which provides data that can be correlated with known wireless networks to obtain location information. Multiple sensors may be arranged in a single physical housing, such as where a single device includes movement, acceleration, temperature, magnetic, position, and/or other sensors. Such a housing also may be referred to as a sensor or a sensor device. For clarity, sensors are described with respect to the particular functions they perform and/or the particular physical hardware used, when such specification is necessary for understanding of the embodiments disclosed herein.

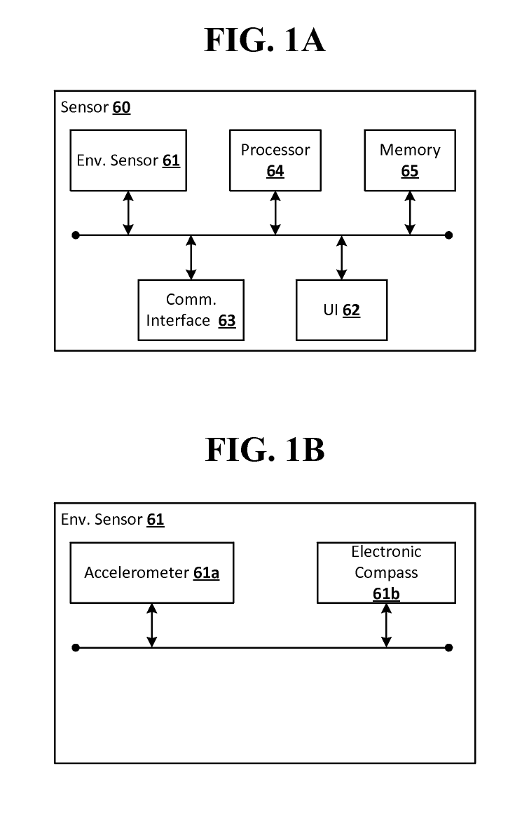

A sensor may include hardware in addition to the specific physical sensor that obtains information about the environment. FIG. 1A shows an example sensor as disclosed herein. The sensor 60 may include an environmental sensor 61, such as a temperature sensor, smoke sensor, carbon monoxide sensor, motion sensor, accelerometer, proximity sensor, passive infrared (PIR) sensor, magnetic field sensor, radio frequency (RF) sensor, light sensor, humidity sensor, pressure sensor, microphone, or any other suitable environmental sensor, that obtains a corresponding type of information about the environment in which the sensor 60 is located.

The sensor 60 may be mounted and/or disposed in a particular position so as to detect motion, vibration, sound, force, acceleration, displacement, or the like. When the sensor 60 is mounted, it may be calibrated and/or configured so as to set a range of motion, displacement, force, acceleration, and the like for the sensor. For example, the sensor 60 may be mounted on or near a door or window of the home to detect motion, vibration, force, acceleration, or the like. The calibration of the sensor 60 may establish, for example, the normal movement range, force, acceleration, vibration, or the like for the door or window.

A processor 64 may receive and analyze data obtained by the sensor 61, control operation of other components of the sensor 60, and process communication between the sensor and other devices. In embodiments of the disclosed subject matter, the processor 64 may analyze the data from the sensor 61, and determine whether the sensor is operating normally. The processor 64 may determine whether the sensor 61 has entered a fault condition (e.g., the sensor has been dislodged and/or fallen from its mounted location) according to the real-time data received from the sensor 61. For example, the processor 64 may compare the received data with pre-stored data characterizing one or more fault events, and may determine the fault condition of the sensor 61 according to the comparison.

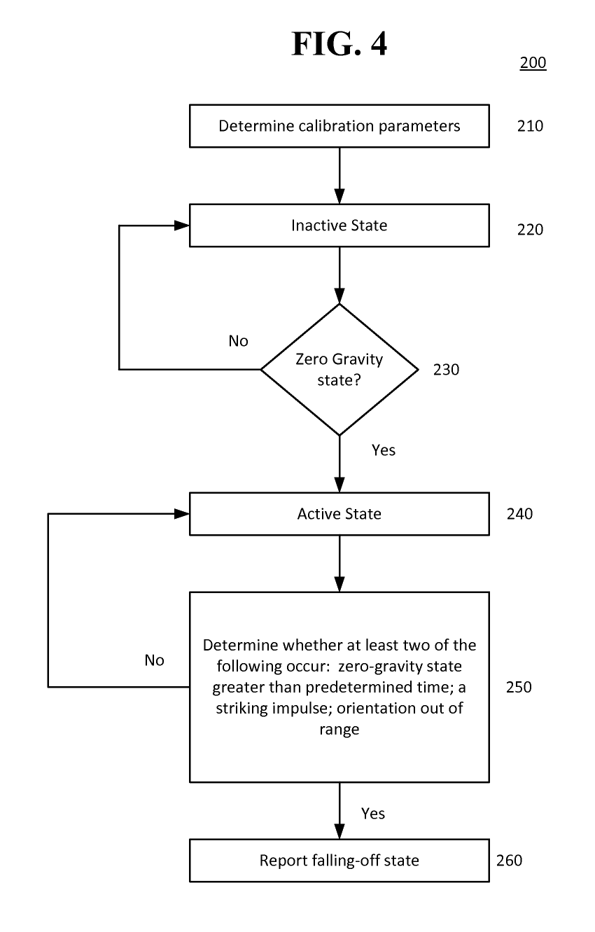

After the sensor 60 is calibrated and/or configured, when the sensor 60 outputs data that is outside the range of motion, displacement, force, acceleration, or the like, the security system and/or processor 64 may determine that the sensor has been dislodged partially or completely from its mounted position (e.g., position has been moved as a result of an intruder or other motion event, and/or the sensor has fallen off). In some embodiments, the sensor 60 may transmit its new location (e.g., to the controller 73 and/or remote system 74 of FIG. 5) if it has been displaced and/or the amount of displacement from the original mounted position from which the sensor 60 was calibrated and/or configured. That is, the system may determine whether the sensor 60 needs to be remounted and/or needs to be recalibrated and/or reconfigured.

The processor 64 may execute instructions stored on a computer-readable memory 65. The memory 65 or another memory in the sensor 60 may also store environmental data obtained by the sensor 61. A communication interface 63, such as a Wi-Fi or other wireless interface, Ethernet or other local network interface, or the like may allow for communication by the sensor 60 with other devices. A user interface (UI) 62 may provide information and/or receive input from a user of the sensor. The UI 62 may include, for example, a speaker to output an audible alarm when an event is detected by the sensor 60. Alternatively, or in addition, the UI 62 may include a light to be activated when an event is detected by the sensor 60. The user interface may be relatively minimal, such as a limited-output display, or it may be a full-featured interface such as a touchscreen. Components within the sensor 60 may transmit and receive information to and from one another via an internal bus or other mechanism as will be readily understood by one of skill in the art. One or more components may be implemented in a single physical arrangement, such as where multiple components are implemented on a single integrated circuit. Sensors as disclosed herein may include other components, and/or may not include all of the illustrative components shown.

In embodiments of the disclosed subject matter, the security system and/or the smart-home environment may determine whether one or more sensors 60 has failed, malfunctioned, lost a portion of a sensing range and/or capability, has been dislodged from its mounted position, or the like. The processor 64 may determine the condition of the sensor according to, for example, the data detected by the sensor. The sensor 60 may transmit a notification (e.g., to a controller of the security system) when the sensor 60 has been at least partially displaced, and/or is unable to detect motion, acceleration, displacement, location, force, or the like in a set configuration range. The notification may include an operating condition of the sensor 60 (e.g., displaced from the mounted location, partial and/or full loss of sensing capability range, or the like). In some embodiments, when the sensor 60 has failed, been at least partially displaced, experienced a loss of at least a portion of sensing functionality, or the like (e.g., as determined by the processor 64 and/or a controller of the security system), one or more other sensors proximately located to the sensor may be used to compensate for the loss of detection, functionality, or the like.

FIG. 1B shows an example sensor according to an embodiment of the disclosed subject matter. In particular, FIG. 1B shows the components of environmental sensor 61 of sensor 60 shown in FIG. 1A and described above. The environmental sensor 61 may include an accelerometer 61a and an electronic compass 61b. The accelerometer 61a may be, for example, a 3-axis microelectromechanical system (MEMS) accelerometer, and/or any other suitable 3-axis accelerometer. In a steady state, the accelerometer 61a may have an orientation defined by the three axes components ax, ay, and az. The accelerometer 61a can be determined to be in a free fall (e.g., the sensor 60 may be dislodged from its set location) when the three axes components ax, ay, and az register that the accelerometer 61a in a zero gravity state for a particular time period.

The environmental sensor 61 shown in FIG. 1B can include the electronic compass 61b, which may be, for example, a 3-axis MEMS electronic compass, and/or any other suitable 3-axis compass. The three axis components bx, by, bz may indicate, for example, a position of a door or window, such as open or closed.

The environmental sensor 61, including the accelerometer 61a and an electronic compass 61b, may provide the ax, ay, and az values and/or the bx, by, bz values being generated in real-time to the processor 64 shown in FIG. 1A for analysis to determine the operational state of the sensor, and to determine the cause of a fault condition, if any, of the environmental sensor 61.

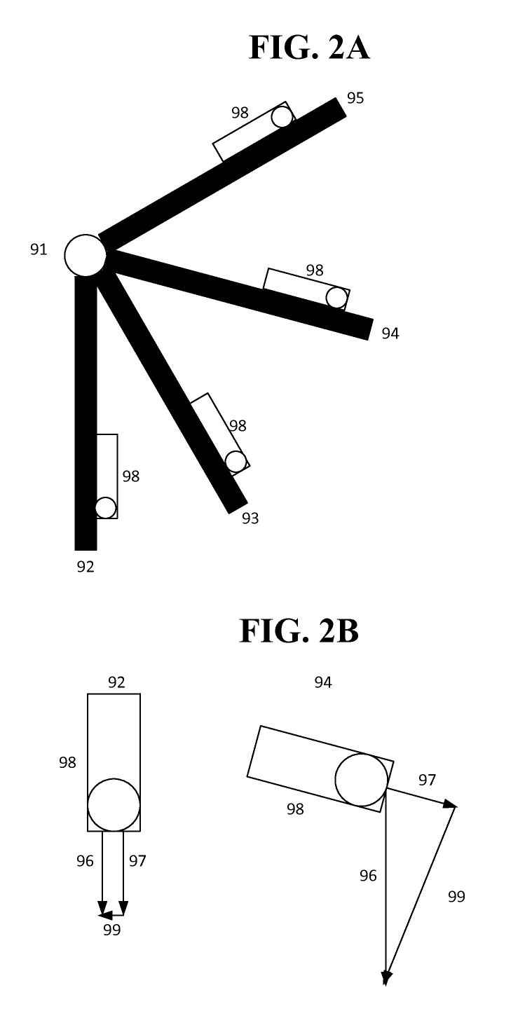

As shown in FIGS. 2A-2B, a security system may include the sensor discussed above that includes an accelerometer and/or an electronic compass. For example, a sensor having an accelerometer and/or an electronic compass (e.g., sensor 98 shown in FIGS. 2A-2B) may be affixed to a door and indicate the status of the door. FIG. 2A shows a schematic representation of an example of a door that opens by a hinge mechanism 81. In a first position 82, the door is closed and the sensor 98 may indicate a first direction. In a closed position, the accelerometer of the sensor may have values of ax_closed, ay_closed, and az_closed, which may represent a calibrated closed state. The door may be opened at a variety of positions, shown as 93, 94, 95. The fourth position 95 may represent the maximum amount the door can be opened. In this open position, the accelerometer of the sensor may have values of ax_open, ay_open, and az_open, which may represent a calibrated open state.

Based on the sensor 98 readings, the position of the door may be determined and/or distinguished more specifically than merely open or closed. In the second position 93, for example, the door may not be far enough apart for a person to enter the home. That is, the three axis components bx, by, bz of the electronic compass may indicate, for example, a position of a door or window. The three axis components ax, ay, az of the accelerometer of the sensor 98 may measure the acceleration of the door as it is opened or closed, and/or may determine whether the sensor 98 has been dislodged by determining a free-fall state of the sensor (e.g., by determining when the sensor 98 enters a zero gravity state for a preset time period). For example, the accelerometer of the sensor 98 may be calibrated with ax_min, ay_min, and az_min values, as well as ax_max, ay_max, and az_max values. The sensor may be determined to have a fault condition, such as being dislodged from its mounting position, when the ax, ay, and az values are outside the range defined by the ax_min, ay_min, and az_min values or ax_max, ay_max, and az_max values. The sensor 98 may transmit a notification of the fault condition to, for example, a controller of the security system. The notification can include the new position of the sensor, the displacement amount of the sensor, the data values that are out of range from the calibrated values, the failure of any component within the sensor, or the like.

In some embodiments, the three axis components ax, ay, az of the accelerometer may be used alone or in combination with other values detected by a sensor to determine whether the sensor 98 has been dislodged, but has not fallen from the sensor's mounting position. For example, if the partially dislodged, it will not experience a free-fall state (e.g., a zero gravity condition) as if it were to fall from its mounting position. Accordingly, the sensor may determine that it is dislodged according to sensor data that indicates the amount of displacement, and/or from data that is detected which is outside of a range of data according to the calibrated ranges for the sensor. In some embodiments, it may be determined that the sensor is displaced by using one or more other sensors of the security system to determine the position of the sensor.

FIG. 2B shows the sensor 98 in two different positions, 92, 94, from FIG. 2A. In the first position 92, the electronic compass of the sensor 98 detects a first direction 96. The compass's direction is indicated as 97 and it may be a known distance from a particular location. For example, when affixed to a door, the electronic compass may automatically determine the distance from the door jamb or a user may input a distance from the doorjamb. The distance representing how far away from the door jamb the door is 99 may be computed by a variety of trigonometric formulas. In the first position 92, the door is indicated as not being separate from the door jamb (i.e., closed) 99. Although features 96 and 97 are shown as distinct in FIG. 2B, they may overlap entirely. In the second position 94, the distance between the door jamb and the door 99 may indicate that the door has been opened wide enough that a person may enter.

In some configurations, the accelerometer of sensor 98 may be employed to indicate how quickly the door is moving. For example, the door may be lightly moving due to a breeze. This may be contrasted with a rapid movement due to a person swinging the door open. The data generated by the electronic compass, accelerometer, and/or magnetometer may be analyzed and/or provided to the processor 64 shown in FIG. 1A and discussed above, and/or a central system such as a controller 73 and/or remote system 74 as discussed below in connection with FIG. 5. The data may be analyzed to learn a user behavior, an environment state, and/or as a component of a home security or home automation system. That is, the controller 73 and/or remote system 74 may receive data in real time from the accelerometer and/or electronic compass of the sensor to monitor its operating condition, and may be alerted of a fault event with the sensor. The controller 73, the remote system 74, and/or the processor 64 may determine the cause of the fault event of the sensor according to the provided data from the accelerometer and/or electronic compass. For example, the provided data may be compared with pre-stored data to determine the cause of the fault event of the sensor.

While the above example shown in FIGS. 2A-2B is described in the context of a door, a person having ordinary skill in the art will appreciate the applicability of the disclosed subject matter to other implementations such as a window (e.g., horizontal sliding window, vertical sliding window, etc.), sliding door, garage door, fireplace doors, vehicle windows/doors, faucet positions (e.g., an outdoor spigot), a gate, seating position, desk drawer, etc.

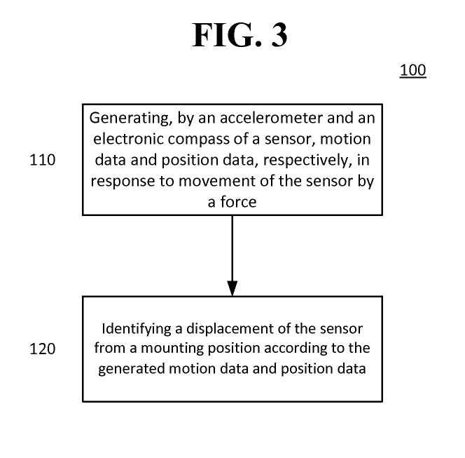

FIG. 3 shows example operations of a method 100 of detecting a falling off event for a sensor (e.g., a sensor dislodgement and/or displacement event) according to embodiments of the disclosed subject matter. An accelerometer and/or an electronic compass of a sensor (e.g., sensor 60 having environmental sensor 61, with accelerometer 61a and electronic compass 61b as shown in FIGS. 1-1B and described above) generate motion data and position data, respectively, in response to movement of the sensor by a force in operation 110. The sensor may be calibrated so as to sense movement and/or direction within a particular range. That is, the three axis components ax, ay, az of the accelerometer and the three axis components bx, by, bz of the electronic compass may be calibrated to have particular maximum and minimum values for normal operation of sensor-detected events, and when the sensor registers values above the maximum values (or below the minimum values), the sensor may be determined to be dislodged and/or have fallen off. Alternatively, or in addition, the values may determine a fault state of the sensor.

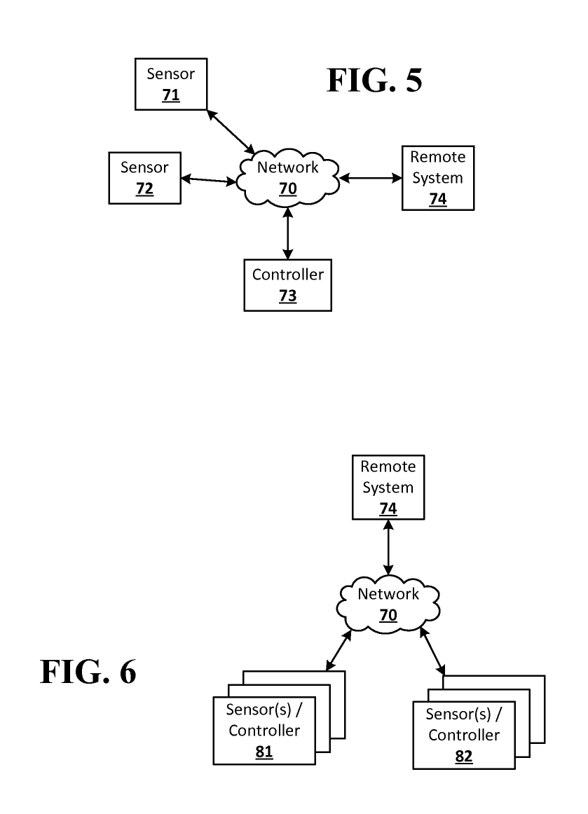

Noise events, such as knocking or banging on a door having a sensor attached, shaking a door having a sensor attached, opening or closing the door having a sensor attached with above normal force, and the like, may be have profiles of ax, ay, az values of the accelerometer and bx, by, bz values of the electronic compass, which may be considered (e.g., by the processor 64 shown in FIG. 1A and described above) when determining whether the sensor has fallen off, or has been dislodged and/or displaced. The sensor may be identified as being displaced from a mounting position according to the generated motion data and position data in operation 120. For example, the processor 64 shown in FIG. 1A, a controller 73 shown in FIG. 5 and discussed below, and/or a remote system 74 shown in FIGS. 5-6 and discussed above may compare the generated motion data and position data generated in real-time by the sensor to determine a fault event, such as a falling off event (e.g., a dislodgement of the sensor). There may be a plurality of fault event scenarios for the sensor. For example, the sensor may be mounted to a door. The displacement and/or dislodgement of the sensor may occur while the door is in a closed position or an open position. The displacement and/or dislodgement of the sensor may occur when the door is being opened or being closed. The processor 64, the controller 73, and/or the remote system 74 may determine, according to the data provided by the sensor, the dislodgement of the sensor, and whether it occurred while the door was opened or closed, or whether it occurred while the door was being opened or closed.

FIG. 4 shows example operations of a method 200 of detecting a falling off event for a sensor according to embodiments of the disclosed subject matter. At operation 210, a sensor and/or a processor of a sensor may determine calibration parameters for the sensor. That is, in operation 210, it may be determined whether the sensor has calibration parameters according to its fixture point (e.g., to a door, a window, or the like), and/or the range of ax, ay, az values of the accelerometer and bx, by, bz values of the electronic compass portions of the sensor (e.g., the maximum and minimum values for ax, ay, az and bx, by, bz). For example, if the sensor is mounted and/or fixed to or near a door or window, the sensor may be calibrated so that the range of motion, acceleration, displacement, force, or the like for the movement of the door or window detected by the sensor may be set.

The calibration of the sensor may include calibrating the sensor so as to establish values for ax, ay, az values of the accelerometer and bx, by, bz values of the electronic compass for particular positions of the sensor. For example, if the sensor is mounted to a door, the calibration data gathered can include obtaining ax, ay, az values of the accelerometer and bx, by, bz values for the open position of the door, as well as the ax, ay, az values of the accelerometer and bx, by, bz values for the closed position of the door. For example, during the calibration operation, an accelerometer sum of squares may be obtained (i.e., ax²+ay²+az²), and a first-order gradient of the electronic compass values may be obtained (i.e., bx²+by²+bz²). The foregoing data may be used to determine, for example, the open and closed values for a sensor mounted, for example, on a door. The sensor may store calibration data for the average values for ax, ay, az values of the accelerometer and bx, by, bz values of the electronic compass in both the closed state and the open state for the door. These calibration values may be used by the sensor and/or processor to determine when a fault event occurs with the sensor, such as a falling off, displacement, and/or dislodgement event.

The processor 64, the controller 73, and/or the remote system 74 may determine whether the calibration parameters for the sensor have been obtained, and the sensor can enter a calibration state to obtain the calibration parameters if they are unavailable. The calibration detection by the processor 64, the controller 73, and/or the remote system 74 may determine a gradient of data from a plurality of axes from the motion data to determine an open or closed state for a door or window, and determine an average value for each of the plurality of axes for the door or window in both the open and closed state. The sensor may enter an inactive state in operation 220, when the calibration parameters have been obtained and the sensor is not in motion (e.g., a static position). That is, in operation 220, the sensor may be in an inactive state, having been calibrated in operation 210.

The embodiments of the disclosed subject matter may detect a falling off event of the sensor, where the sensor is displaced and/or dislodged from its mounted position. For example, the processor 64, the controller 73, and/or the remote system 74 can determine a stage of movement of the sensor from the generated motion data and position data from the accelerometer and the electronic compass, respectively. Sensor events may be detected according to particular time periods. A first time period may be prior to movement of the sensor, a second time period may include a falling motion of the sensor in response to movement of the sensor by the force, a third time period may include the sensor striking a surface (e.g., after falling off of its mounted position), and a fourth time period may include a new position of the sensor (e.g., the sensor coming to rest after the fall). A sensor event may be at least one of a calibration detection, a zero gravity detection, an impulse detection, and an orientation change detection. In embodiments of the disclosed subject matter, the type of event may be determined by the processor 64, the controller 73, and/or the remote system 74 from the data provided by the sensor in real-time. The processor 64, the controller 73, and/or the remote system 74 may compare the acquired data with pre-stored data to determine the type of event. In some embodiments, the processor 64, the controller 73, and/or the remote system 74 may determine the cause of the event and/or fault state of the sensor according to the acquired data from the sensor.

At operation 230, the sensor may detect changes in the ax, ay, az values of the accelerometer and/or the bx, by, bz values of the electronic compass of the sensor, and may determine whether the sensor is entering a zero gravity state. A zero gravity state of the sensor may be determined according to data from the accelerometer of the sensor for a time window. In an embodiment of the disclosed subject matter, the processor 64, the controller 73, and/or the remote system 74 may remove noise from the gathered accelerometer, and determine the beginning and conclusion of the zero gravity state. When a zero gravity state is detected, changes to the ax, ay, az values are detected, and/or changes to the bx, by, bz values are detected, the sensor transitions from an inactive state to an active state at operation 240.

At operation 250, the processor of the sensor may determine whether at least two of the following occur to determine whether the sensor has been dislodged, displaced, and/or had a falling off event: a zero-gravity state greater than predetermined time, a striking impulse detected, and an orientation out of range.

The processor of the sensor can determine that the sensor is in a zero gravity state according to the data being provided by the sensor. Using the data collected by the accelerometer of the sensor, the processor determines the length of the zero gravity state by determining the starting point and ending point of the zero gravity state. When the detected zero gravity state is greater than a preset period of time, the sensor may be determined to be dislodged from its sensing position. In some embodiments, a noise filter may be used to filter the accelerometer data so that initiation, conclusion, and length (e.g., length in time) of a zero gravity state of the sensor may be more accurately determined.

The impulse detection by the processor of the sensor can determine an end of a zero gravity state. That is, the impulse detection may determine when a sensor has a falling event, where the impulse that is detected is from the sensor impacting a surface after free fall. The processor of the sensor can determine whether a maximum value of data from the sensor after the end of the zero gravity state is greater than a predetermined value. This maximum value may be the force from when the sensor impacts a surface if it has fallen or been dislodged.

The processor 64, the controller 73, and/or the remote system 74 may determine orientation change (e.g., the change in the ax, ay, and az values and/or bx, by, and bz values) of the sensor. For example, the processor 64, the controller 73, and/or the remote system 74 may compare the ax, ay, and az values acquired by the sensor with maximum and minimum calibration data values, and may determine whether the motion data is within an error range.

That is, in operation 250, by determining whether a zero-gravity state is greater than predetermined time, a striking impulse detected, and an orientation out of range, the sensor, processor 64, the controller 73, and/or the remote system 74 may determine if the sensor has had a falling off event (e.g., the sensor has been dislodged and/or dislocated from its set position). If a falling off state of the sensor has been detected, the sensor may report the dislocation of the sensor to the processor 64 and/or a controller of a sensor network (e.g., controller 73 and/or remote system 74 shown in FIGS. 5-6) at operation 260.

In the reporting operation 260, the sensor may provide a location of the dislodged sensor according to the electronic compass, and may provide a reason for dislodgement. For example, the sensor may have a preset range of values for the ax, ay, and az values and/or bx, by, and bz values to identify how the sensor was removed. For example, it could be removed by force, it may have merely fallen off, or the like. That is, the obtained sensor data may be compared with pre-stored data to determine a type of fault event (e.g., the sensor being dislodged), and/or to determine the cause of the fault event.

The fault event can be determined, for example, by comparing the calibration parameters of the sensor (e.g., as determined in operation 210) with the obtained sensor data. That is, the processor 64 shown in FIG. 1A, the controller 73 shown in FIG. 5, and/or the remote system 74, or the like may compare the calibration parameters from the sensor with the obtained sensor data. When the obtained sensor data does not fall within the range of the calibration parameters, a fault event can be determined. The processor 64 shown in FIG. 1A, the controller 73 shown in FIG. 5, and/or the remote system 74, may determine a fault of the sensor from a predetermined set of faults according to which data of the obtained sensor data is outside the range of the calibration parameters. Alternatively, or in addition, the obtained sensor data may be compared with a predetermined set of fault conditions to determine which fault condition for the set of fault conditions has a parameter range that the obtained sensor data falls within. The set of fault conditions may include, for example, when the sensor falls from its set position from a door while the door is open, while the door is closed, and/or while the door is moving (e.g., being opened or closed).

In some embodiments, the data from the sensor may be used to determine whether the sensor has been dislodged and/or displaced from its mounted position, but has not fallen. For example, the data detected by the sensor may be outside of the calibrated range of values for the sensor. The sensor data may determine that a force occurred so as to move and/or displace the sensor, but that no free-fall and/or zero gravity state of the sensor occurred. After the displacement and/or dislodgement, the sensor may transmit its location and/or operating condition to the security system. If the functionality of the sensor has been reduced, and/or the sensor has failed, the security system may use one or more other sensors within a predetermined proximity to sense, for example, the movement of a door or window that the sensor was monitoring before its detecting capacity was diminished.

Sensors as disclosed herein may operate within a communication network, such as shown in FIG. 5, and/or as a conventional wireless network, and/or a sensor-specific network through which sensors may communicate with one another and/or with dedicated other devices. In some configurations one or more sensors may provide information to one or more other sensors, to a central controller, or to any other device capable of communicating on a network with the one or more sensors. A central controller may be general- or special-purpose. For example, one type of central controller is a home automation network that collects and analyzes data from one or more sensors within the home. Another example of a central controller is a special-purpose controller that is dedicated to a subset of functions, such as a security controller that collects and analyzes sensor data primarily or exclusively as it relates to various security considerations for a location. A central controller may be located locally with respect to the sensors with which it communicates and from which it obtains sensor data, such as in the case where it is positioned within a home that includes a home automation and/or sensor network. Alternatively or in addition, a central controller as disclosed herein may be remote from the sensors, such as where the central controller is implemented as a cloud-based system that communicates with multiple sensors, which may be located at multiple locations and may be local or remote with respect to one another.

FIG. 5 shows an example of a sensor network as disclosed herein, which may be implemented over any suitable wired and/or wireless communication networks. One or more sensors 71, 72 may communicate via a local network 70, such as a Wi-Fi or other suitable network, with each other and/or with a controller 73.

FIG. 5 shows an example of a security system as disclosed herein, which may be implemented over any suitable wired and/or wireless communication networks. One or more sensors 71, 72 may communicate via a local network 70, such as a Wi-Fi or other suitable network, with each other and/or with a controller 73. The devices of the security system and smart-home environment of the disclosed subject matter may be communicatively connected via the network 70, which may be a mesh-type network such as Thread, which provides network architecture and/or protocols for devices to communicate with one another. Typical home networks may have a single device point of communications. Such networks may be prone to failure, such that devices of the network cannot communicate with one another when the single device point does not operate normally. The mesh-type network of Thread, which may be used in the security system of the disclosed subject matter, may avoid communication using a single device. That is, in the mesh-type network, such as network 70, there is no single point of communication that may fail so as to prohibit devices coupled to the network from communicating with one another.

The communication and network protocols used by the devices communicatively coupled to the network 70 may provide secure communications, minimize the amount of power used (i.e., be power efficient), and support a wide variety of devices and/or products in a home, such as appliances, access control, climate control, energy management, lighting, safety, and security. For example, the protocols supported by the network and the devices connected thereto may have an open protocol which may carry IPv6 natively.

The Thread network, such as network 70, may be easy to set up and secure to use. The network 70 may use an authentication scheme, AES (Advanced Encryption Standard) encryption, or the like to reduce and/or minimize security holes that exist in other wireless protocols. The Thread network may be scalable to connect devices (e.g., 2, 5, 10, 20, 50, 100, 150, 200, or more devices) into a single network supporting multiple hops (e.g., so as to provide communications between devices when one or more nodes of the network is not operating normally). The network 70, which may be a Thread network, may provide security at the network and application layers. One or more devices communicatively coupled to the network 70 (e.g., controller 73, remote system 74, and the like) may store product install codes to ensure only authorized devices can join the network 70. One or more operations and communications of network 70 may use cryptography, such as public-key cryptography.

The devices communicatively coupled to the network 70 of the smart-home environment and/or security system disclosed herein may low power consumption and/or reduced power consumption. That is, devices efficiently communicate to with one another and operate to provide functionality to the user, where the devices may have reduced battery size and increased battery lifetimes over conventional devices. The devices may include sleep modes to increase battery life and reduce power requirements. For example, communications between devices coupled to the network 70 may use the power-efficient IEEE 802.15.4 MAC/PHY protocol. In embodiments of the disclosed subject matter, short messaging between devices on the network 70 may conserve bandwidth and power. The routing protocol of the network 70 may reduce network overhead and latency. The communication interfaces of the devices coupled to the smart-home environment may include wireless system-on-chips to support the low-power, secure, stable, and/or scalable communications network 70.

The controller 73 shown in FIG. 5 may be a general- or special-purpose computer. The controller 73 may, for example, receive, aggregate, and/or analyze environmental information received from the sensors 71, 72. That is, the controller 73 may receive, aggregate, and/or analyze accelerometer and/or electronic compass information in real-time to determine a fault condition for a sensor. Alternatively, or in addition, the controller 73 may receive a fault condition from the sensor.

The sensors 71, 72 and the controller 73 may be located locally to one another, such as within a single dwelling, office space, building, room, or the like, or they may be remote from each other, such as where the controller 73 is implemented in a remote system 74 such as a cloud-based reporting and/or analysis system. Alternatively or in addition, sensors may communicate directly with a remote system 74. The remote system 74 may, for example, aggregate data from multiple locations, provide instruction, software updates, and/or aggregated data to a controller 73 and/or sensors 71, 72.

The sensor network shown in FIG. 5 may be an example of a smart-home environment. The depicted smart-home environment may include a structure, a house, office building, garage, mobile home, or the like. The devices of the smart home environment, such as the sensors 71, 72, the controller 73, and the network 70 may be integrated into a smart-home environment that does not include an entire structure, such as an apartment, condominium, or office space.

The smart home environment can control and/or be coupled to devices outside of the structure. For example, one or more of the sensors 71, 72 may be located outside the structure, for example, at one or more distances from the structure (e.g., sensors 71, 72 may be disposed outside the structure, at points along a land perimeter on which the structure is located, and the like. One or more of the devices in the smart home environment need not physically be within the structure. For example, the controller 73 which may receive input from the sensors 71, 72 may be located outside of the structure.

The structure of the smart-home environment may include a plurality of rooms, separated at least partly from each other via walls. The walls can include interior walls or exterior walls. Each room can further include a floor and a ceiling. Devices of the smart-home environment, such as the sensors 71, 72, may be mounted on, integrated with and/or supported by a wall, floor, or ceiling of the structure.

The smart-home environment including the sensor network shown in FIG. 5 may include a plurality of devices, including intelligent, multi-sensing, network-connected devices that can integrate seamlessly with each other and/or with a central server or a cloud-computing system (e.g., controller 73 and/or remote system 74) to provide home-security and smart-home features. The smart-home environment may include one or more intelligent, multi-sensing, network-connected thermostats (e.g., “smart thermostats”), one or more intelligent, network-connected, multi-sensing hazard detection units (e.g., “smart hazard detectors”), and one or more intelligent, multi-sensing, network-connected entryway interface devices (e.g., “smart doorbells”). The smart hazard detectors, smart thermostats, and smart doorbells may be the sensors 71, 72 shown in FIG. 5.

For example, a smart thermostat may detect ambient climate characteristics (e.g., temperature and/or humidity) and may control an HVAC (heating, ventilating, and air conditioning) system accordingly of the structure. For example, the ambient client characteristics may be detected by sensors 71, 72 shown in FIG. 5, and the controller 73 may control the HVAC system (not shown) of the structure.

As another example, a smart hazard detector may detect the presence of a hazardous substance or a substance indicative of a hazardous substance (e.g., smoke, fire, or carbon monoxide). For example, smoke, fire, and/or carbon monoxide may be detected by sensors 71, 72 shown in FIG. 5, and the controller 73 may control an alarm system to provide a visual and/or audible alarm to the user of the smart-home environment.

As another example, a smart doorbell may control doorbell functionality, detect a person's approach to or departure from a location (e.g., an outer door to the structure), and announce a person's approach or departure from the structure via audible and/or visual message that is output by a speaker and/or a display coupled to, for example, the controller 73.

In some embodiments, the smart-home environment of the sensor network shown in FIG. 5 may include one or more intelligent, multi-sensing, network-connected wall switches (e.g., “smart wall switches”), one or more intelligent, multi-sensing, network-connected wall plug interfaces (e.g., “smart wall plugs”). The smart wall switches and/or smart wall plugs may be or include one or more of the sensors 71, 72 shown in FIG. 5. A smart wall switch may detect ambient lighting conditions, and control a power and/or dim state of one or more lights. For example, a sensor such as sensors 71, 72, may detect ambient lighting conditions, and a device such as the controller 73 may control the power to one or more lights (not shown) in the smart-home environment. Smart wall switches may also control a power state or speed of a fan, such as a ceiling fan. For example, sensors 72, 72 may detect the power and/or speed of a fan, and the controller 73 may adjusting the power and/or speed of the fan, accordingly. Smart wall plugs may control supply of power to one or more wall plugs (e.g., such that power is not supplied to the plug if nobody is detected to be within the smart-home environment). For example, one of the smart wall plugs may controls supply of power to a lamp (not shown).

In embodiments of the disclosed subject matter, a smart-home environment may include one or more intelligent, multi-sensing, network-connected entry detectors (e.g., “smart entry detectors”). Such detectors may be or include one or more of the sensors 71, 72 shown in FIG. 5. The illustrated smart entry detectors (e.g., sensors 71, 72) may be disposed at one or more windows, doors, and other entry points of the smart-home environment for detecting when a window, door, or other entry point is opened, broken, breached, and/or compromised. The smart entry detectors may generate a corresponding signal to be provided to the controller 73 and/or the remote system 74 when a window or door is opened, closed, breached, and/or compromised. In some embodiments of the disclosed subject matter, the alarm system, which may be included with controller 73 and/or coupled to the network 70 may not arm unless all smart entry detectors (e.g., sensors 71, 72) indicate that all doors, windows, entryways, and the like are closed and/or that all smart entry detectors are armed.

The smart-home environment of the sensor network shown in FIG. 5 can include one or more intelligent, multi-sensing, network-connected doorknobs (e.g., “smart doorknob”). For example, the sensors 71, 72 may be coupled to a doorknob of a door (e.g., doorknobs 122 located on external doors of the structure of the smart-home environment). However, it should be appreciated that smart doorknobs can be provided on external and/or internal doors of the smart-home environment.

The smart thermostats, the smart hazard detectors, the smart doorbells, the smart wall switches, the smart wall plugs, the smart entry detectors, the smart doorknobs, the keypads, and other devices of a smart-home environment (e.g., as illustrated as sensors 71, 72 of FIG. 5 can be communicatively coupled to each other via the network 70, and to the controller 73 and/or remote system 74 to provide security, safety, and/or comfort for the smart home environment).

A user can interact with one or more of the network-connected smart devices (e.g., via the network 70). For example, a user can communicate with one or more of the network-connected smart devices using a computer (e.g., a desktop computer, laptop computer, tablet, or the like) or other portable electronic device (e.g., a smartphone, smart watch, wearable computing device, a tablet, a key FOB, and the like). A webpage or application can be configured to receive communications from the user and control the one or more of the network-connected smart devices based on the communications and/or to present information about the device's operation to the user. For example, the user can view can arm or disarm the security system of the home.

In another example, the user may receive information and/or a notification, in real-time, regarding a fault condition of a sensor, such as a falling off event. The notification may provide information about the present location of the sensor after being dislodged, and may provide information regarding the cause of the fault condition.

One or more users can control one or more of the network-connected smart devices in the smart-home environment using a network-connected computer or portable electronic device. In some examples, some or all of the users (e.g., individuals who live in the home) can register their mobile device and/or key FOBs with the smart-home environment (e.g., with the controller 73). Such registration can be made at a central server (e.g., the controller 73 and/or the remote system 74) to authenticate the user and/or the electronic device as being associated with the smart-home environment, and to provide permission to the user to use the electronic device to control the network-connected smart devices and the security system of the smart-home environment. A user can use their registered electronic device to remotely control the network-connected smart devices and security system of the smart-home environment, such as when the occupant is at work or on vacation. The user may also use their registered electronic device to control the network-connected smart devices when the user is located inside the smart-home environment.

Alternatively, or in addition to registering electronic devices, the smart-home environment may make inferences about which individuals live in the home and are therefore users and which electronic devices are associated with those individuals. As such, the smart-home environment may “learn” who is a user (e.g., an authorized user) and permit the electronic devices associated with those individuals to control the network-connected smart devices of the smart-home environment (e.g., devices communicatively coupled to the network 70), in some embodiments including sensors used by or within the smart-home environment. Various types of notices and other information may provide to users via messages sent to one or more user electronic devices. For example, the messages can be sent via email, short message service (SMS), multimedia messaging service (MMS), unstructured supplementary service data (USSD), as well as any other type of messaging services and/or communication protocols.

A smart-home environment may include communication with devices outside of the smart-home environment but within a proximate geographical range of the home. For example, the smart-home environment may include an outdoor lighting system (not shown) that communicates information through the communication network 70 or directly to a central server or cloud-computing system (e.g., controller 73 and/or remote system 74) regarding detected movement and/or presence of people, animals, and any other objects and receives back commands for controlling the lighting accordingly.

The controller 73 and/or remote system 74 can control the outdoor lighting system based on information received from the other network-connected smart devices in the smart-home environment. For example, in the event, any of the network-connected smart devices, such as smart wall plugs located outdoors, detect movement at night time, the controller 73 and/or remote system 74 can activate the outdoor lighting system and/or other lights in the smart-home environment.

In some configurations, as shown in FIG. 6, a remote system 74 may aggregate data from multiple locations, such as multiple buildings, multi-resident buildings, individual residences within a neighborhood, multiple neighborhoods, and the like. In general, multiple sensor/controller systems 81, 82 as previously described with respect to FIG. 5 may provide information to the remote system 74. The systems 81, 82 may provide data directly from one or more sensors as previously described, or the data may be aggregated and/or analyzed by local controllers such as the controller 73, which then communicates with the remote system 74. The remote system may aggregate and analyze the data from multiple locations, and may provide aggregate results to each location. For example, the remote system 74 may examine larger regions for common sensor data or trends in sensor data, and provide information on the identified commonality or environmental data trends to each local system 81, 82.

The remote system 74 of FIG. 6 may aggregate data regarding fault events from sensors, so that data profiles may be stored for particular fault events, so that real-time sensor data can be compared with stored data profiles. That is, the remote system 74 may determine a type of fault event and a cause of a fault event of a sensor according to a comparison of the received real-time data and the aggregated data.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, specific information about a user's residence may be treated so that no personally identifiable information can be determined for the user, or a user's geographic location may be generalized where location information is obtained (such as to a city, ZIP code, or state level), so that a particular location of a user cannot be determined. As another example, systems disclosed herein may allow a user to restrict the information collected by those systems to applications specific to the user, such as by disabling or limiting the extent to which such information is aggregated or used in analysis with other information from other users. Thus, the user may have control over how information is collected about the user and used by a system as disclosed herein.

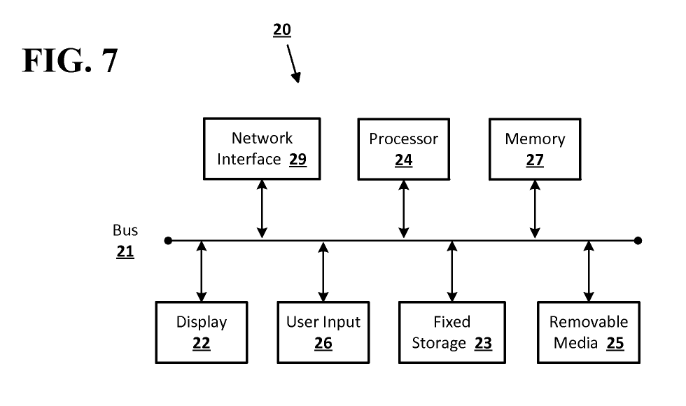

Embodiments of the presently disclosed subject matter may be implemented in and used with a variety of computing devices. FIG. 7 is an example computing device 20 suitable for implementing embodiments of the presently disclosed subject matter. For example, the device 20 may be used to implement a controller, a device including sensors as disclosed herein, or the like. Alternatively or in addition, the device 20 may be, for example, a desktop or laptop computer, or a mobile computing device such as a smart phone, smart watch, wearable computing device, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components 25, 27, which may include RAM, ROM, and other memory, as previously noted. Applications resident with the computer 20 are generally stored on and accessed via a computer readable storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the device to communicate with other computers via one or more local, wide-area, or other communication networks, as described in further detail herein.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing embodiments of the disclosed subject matter. When implemented on a general-purpose microprocessor, the computer program code may configure the microprocessor to become a special-purpose device, such as by creation of specific logic circuits as specified by the instructions.

Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A system comprising:
a sensor including an accelerometer and an electronic compass to generate motion data and position data, respectively, in response to movement of the sensor by a force; and
a processor communicatively coupled to the sensor,
wherein the processor identifies a displacement of the sensor from a mounting position according to the generated motion data and position data that is transmitted to the processor.

2. The system of claim 1, wherein the processor determines a free-fall state of the sensor according to the generated motion data and position data transmitted from the sensor.

3. The system of claim 2, wherein the processor determines that the sensor is in the free-fall state when acceleration of the sensor approaches zero gravity.

4. The system of claim 1, wherein the processor determines a stage of movement of the sensor from the generated motion data and position data, according to at least one of the group consisting of: a first time period that is prior to movement of the sensor, a second time period that includes a falling motion of the sensor in response to movement of the sensor by the force, a third time period that includes the sensor striking a surface, and a fourth time period that includes a new position of the sensor.

5. The system of claim 1, wherein the processor determines a sensor event according to at least one of a group consisting of: a calibration detection, a zero gravity detection, an impulse detection, and an orientation change detection.

6. The system of claim 5, wherein the calibration detection by the processor determines a gradient of data from a plurality of axes from the motion data to determine an open or closed state for a door or window, and determine an average value for each of the plurality of axes for the door or window in both the open and closed state.

7. The system of claim 6, wherein the processor determines whether the calibration parameters for the sensor have been obtained, and the sensor enters a calibration state to obtain the calibration parameters if they are unavailable, and the sensor enters an inactive state when the calibration parameters have been obtained.

8. The system of claim of claim 5, wherein the zero gravity detection by the processor determines a zero gravity state of the sensor according to data from a plurality of axes from the motion detector over a time window, the processor to remove noise from the data and determine the beginning and conclusion of the zero gravity state.

9. The system of claim 8, wherein when a zero gravity state is detected, the sensor transitions from an inactive state to an active state.

10. The system of claim 5, wherein the impulse detection by the processor determines a start and end of a zero gravity state, and the processor determines whether a maximum value of data from the sensor after the end of the zero gravity state is greater than a predetermined value.

11. The system of claim 5, wherein the orientation change detection by the processor compares the motion data acquired by the sensor with maximum and minimum calibration data values, determines whether the motion data is within an error range.

12. The system of claim 1, wherein the processor determines that the sensor is in a falling state when the sensor registers at least two from the group consisting of: a zero gravity state of the sensor being longer than a predetermined time, detection of a striking pulse, and orientation data from motion data and position data being outside of a predetermined range.

13. A method comprising:
generating, by an accelerometer and an electronic compass of a sensor, motion data and position data, respectively, in response to movement of the sensor by a force; and
identifying, based upon the generated motion data and the position data, a displacement of the sensor from a mounting position.

14. The method of claim 13, further comprising:
determining, by the processor, a free-fall state of the sensor according to the generated motion data and position data transmitted from the sensor.

15. The method of claim 14, further comprising:
determining, by the processor, that the sensor is in the free-fall state when acceleration of the sensor approaches zero gravity.

16. The method of claim 13, further comprising:
determining, by the processor, a stage of movement of the sensor from the generated motion data and position data, according to at least one of the group consisting of: a first time period that is prior to movement of the sensor, a second time period that includes a falling motion of the sensor in response to movement of the sensor by the force, a third time period that includes the sensor striking a surface, and a fourth time period that includes a new position of the sensor.

17. The method of claim 13, further comprising:
determining, with the processor, a sensor event according to at least one of a group consisting of: a calibration detection, a zero gravity detection, an impulse detection, and an orientation change detection.

18. The method of claim 17, wherein the calibration detection by the processor comprises:
determining a gradient of data from a plurality of axes from the motion data to determine an open or closed state for a door or window; and
determining an average value for each of the plurality of axes for the door or window in both the open and closed state.

19. The method of claim 18, further comprising:
determining whether the calibration parameters for the sensor have been obtained;
entering, by the sensor, a calibration state to obtain the calibration parameters if they are unavailable; and
entering, by the sensor enters, an inactive state when the calibration parameters have been obtained.

20. The method of claim of claim 17, wherein the zero gravity detection by the processor comprises:
determining a zero gravity state of the sensor according to data from a plurality of axes from the motion detector over a time window;
removing noise from the data; and
determining the beginning and conclusion of the zero gravity state.

21. The method of claim 20, father comprising:
when a zero gravity state is detected, the sensor transitions from an inactive state to an active state.

22. The method of claim 17, wherein the impulse detection by the processor comprises:
determining a start and end of a zero gravity state; and
determining whether a maximum value of data from the sensor after the end of the zero gravity state is greater than a predetermined value.

23. The method of claim 17, wherein the orientation change detection by the processor comprise:
comparing the motion data acquired by the sensor with maximum and minimum calibration data values; and
determining whether the motion data is within an error range.

24. The method of claim 13, further comprising:
determining, with the processor, that the sensor is in a falling state when the sensor registers at least two from the group consisting of: a zero gravity state of the sensor being longer than a predetermined time, detection of a striking pulse, and orientation data from motion data and position data being outside of a predetermined range.
